(19) United States
(12) Patent Application Publication
(10) Pub. No.: US 2020/0335818 A1
(43) Pub. Date: Oct. 22, 2020

(54) Porous Ceramic Fibers for Electrolyte Support and Processing

(71) Applicant: Robert Bosch GmbH, Stuttgart (DE)

(72) Inventors: John F. Christensen, Elk Grove, CA (US); Jonathan Mailoa, Cambridge, MA (US); Boris Kozinsky, Waban, MA (US); Georgy Samsonidze, San Francisco, CA (US); Ram Subbaraman, Sunnyvale, CA (US); Mordechai Kornbluth, Brighton, MA (US)

(21) Appl. No.: 16/956,287

(22) PCT Filed: Dec. 13, 2018
(86) PCT No.: PCT/EP2018/084826

§ 371 Date: Jun. 19, 2020

Related U.S. Application Data
(60) Provisional application No. 62/609,946, filed on Dec. 22, 2017.

(51) Int. Cl. H01M 10/0562; H01M 10/052; H01M 4/38; H01M 10/058

(52) U.S. Cl. CPC H01M 10/0562; H01M 10/052; H01M 4/382; H01M 2004/027; H01M 2300/0094; H01M 2300/0068; H01M 2300/0071; H01M 10/058

(57) ABSTRACT

An electrolyte structure for a battery cell includes a first portion configured as a thin film solid electrolyte and a second portion disposed adjacent to the first portion. The second portion includes a porous ceramic fiber material that contacts the electrolyte. The electrolyte structure is configured to be positioned between a positive electrode and a lithium metal negative electrode. The porous ceramic fiber material mechanically supports the electrolyte by strengthening it against internal and external stresses associated with fabrication and/or operation of the battery cell. The porous ceramic fiber material also provides a substrate on which the electrolyte is deposited, grown, or otherwise formed. In one embodiment, the second portion with the porous ceramic fiber material is configured to be removed after the electrolyte structure is positioned between the positive and negative electrodes. The electrolyte in one embodiment is formed from lithium phosphorous oxynitride (LiPON).

This application claims the benefit of U.S. Provisional Application 62/609,946, filed Dec. 22, 2017, the disclosure of which is incorporated herein by reference in its entirety.

### GOVERNMENT RIGHTS NOTICE

This invention was made with government support under DE-AR0000775 awarded by the U.S. Department of Energy, Advanced Research Projects Agency—Energy (ARPA-E). The government has certain rights in the invention.

### FIELD

The disclosure relates to batteries and more particularly to a battery that includes a thin film solid electrolyte supported by or processed with a porous ceramic fiber material.

### BACKGROUND

Batteries are a useful source of stored energy that can be incorporated into a number of systems. Rechargeable lithium-ion (“Li-ion”) batteries are attractive energy storage systems for portable electronics and electric and hybrid-electric vehicles because of their high specific energy compared to other electrochemical energy storage devices. In particular, batteries with a form of lithium (“Li”) metal incorporated into the negative electrode or anode afford exceptionally high specific energy (measured in Wh/kg) and energy density (measured in Wh/L) compared to batteries with conventional carbonaceous negative electrodes.

A battery generally consists of an anode, a cathode, and an electrolyte therebetween. The electrolyte is configured to move ions while resisting the flow of electrons, which allows electrons to move outside the battery to provide useful work. The cathode and anode are separated by a separator, which is typically configured to prevent electron transport that may cause short circuits, prevent transport of a liquid electrolyte, and prevent Li dendrite growth. Existing separators for batteries come in different forms and materials. One example is a separator formed from porous ceramic fiber. The material of these ceramic fiber separators is considered porous because the material allows Li ions to move between the anode and the cathode, but it is used as a “separator” to prevent electric short-circuits and/or prevent transport of a liquid electrolyte. Separators formed from porous ceramic fiber demonstrate mechanical strength and thermal stability among other desired attributes. These separators are often formed from popular ceramics such as titanium oxide and other transition-metal oxides.

Existing rechargeable Li-ion batteries often use liquid electrolytes due to the relatively high ion conduction of liquid electrolytes. A significant further advantage of using a liquid or polymer electrolyte is its ability to accommodate volume changes in cathode active material (“CAM”) particles, which change volume as lithium is inserted and extracted during battery cycling. In contrast, a fully ceramic battery may undergo fatigue and fracture, especially within the cathode, due to these volume changes. Another advantage of a liquid catholyte is better wetting of all surfaces of the CAM, allowing better utilization of the CAM.

In spite of these advantages, liquid electrolytes are generally flammable substances, raising safety concerns. Liquid electrolytes are also incompatible with Li-metal anodes, preventing higher energy densities. The industry is moving towards solid-state batteries, which include a solid electrolyte, to mitigate these concerns. A challenge with the shift to using solid electrolytes is to find an electrolyte that possesses the following attributes: (1) the solid electrolyte is electrochemically stable with respect to the desired cathode and anode; (2) the solid electrolyte has the desired ionic conductivity without electronic conductivity; and (3) the solid electrolyte has the mechanical strength, temperature stability, and other requirements for safety and fast charging.

One promising class of solid electrolyte materials includes thin-film-based glassy materials, such as LiPON. LiPON is a well-known electrolyte used in thin-film Li metal battery cells. A significant advantage of glassy materials such as UPON as the Li-metal-facing electrolyte is its lack of grain boundaries. Grain boundaries are a point of failure, where Li filaments can grow along the grain boundary and eventually short the cell. The lack of grain boundaries in electrolytes formed from UPON generally precludes growth of Li filaments.

Glassy materials, such as LiPON, do suffer from some issues. For instance, LiPON is generally considered to have less-desirable mechanical strength. Moreover, LiPON is typically formed via sputtering onto a substrate or via deposition onto a substrate by some other process. When the substrate melts during deposition, the resulting surface is not smooth or uniform, which can increase interfacial resistivity and/or increase mechanical stresses, thereby lowering the overall mechanical stability of the material. Additionally, LiPON is generally grown via an expensive vacuum deposition process, and its Li-ion conductivity is approximately 1e−6 S/cm at room temperature. Thus, LiPON is typically deposited as a thin layer in a range of 100 nanometers to several microns for practical high-current usage. While solid electrolytes can be formed from other glassy materials with higher conductivities (e.g., sulfides with up to 1e−2 S/cm), electrolytes formed from these other glassy materials still suffer from less-desirable mechanical strength and are formed with similar deposition processes.

What is needed, therefore, is a thin film electrolyte with increased mechanical strength and improved processability.

### SUMMARY

A solid-state battery cell in one embodiment includes a positive electrode, a negative electrode that includes lithium metal, and an electrolyte structure disposed between the positive electrode and the negative electrode, the electrolyte structure including a first portion configured as a thin film solid electrolyte and a second portion positioned adjacent to the first portion, the second portion including a porous ceramic fiber material that contacts the thin film solid electrolyte. The porous ceramic fiber material mechanically supports the thin film solid electrolyte by strengthening the electrolyte from internal and external stresses associated with fabrication and operation of the battery cell. The porous ceramic fiber material enhances adhesion with the thin film solid electrolyte, the positive electrode, and the negative electrode. The porous ceramic fiber material is configured as a substrate on which the thin film solid electrolyte is deposited, grown, or otherwise formed.

A battery cell in one embodiment includes a negative electrode that includes lithium metal, a porous composite positive electrode that includes particles of active material and liquid electrolyte, and an electrolyte structure disposed between the negative electrode and the positive electrode, the electrolyte structure including a first portion configured as thin film solid electrolyte and a second portion positioned adjacent to the first portion, the second portion including a porous ceramic fiber material that contacts the thin film solid electrolyte, the first portion of the electrolyte structure contacts the negative electrode and the pores of the porous ceramic fiber material are filled with the liquid electrolyte.

A method for producing a battery cell in one embodiment includes fabricating an electrolyte structure by forming a first portion configured as a thin film solid electrolyte on a second portion that includes a porous ceramic fiber material, the porous ceramic fiber material contacting the thin film solid electrolyte, and positioning the electrolyte structure between a positive electrode and a lithium metal negative electrode of the battery cell such that the electrolyte structure contacts the positive electrode and the negative electrode.

### BRIEF DESCRIPTION OF THE DRAWINGS

FIG. 1 depicts a simplified schematic of an electrochemical cell with an electrolyte structure including a thin-film solid electrolyte and a porous ceramic fiber substrate in a first arrangement in the cell;

FIG. 2. depicts a simplified schematic of an electrochemical cell with an electrolyte structure including a thin-film solid electrolyte and a porous ceramic fiber substrate in a second arrangement in the cell;

FIG. 3 depicts a simplified schematic of a hybrid electrochemical cell with an electrolyte structure including a thin-film solid electrolyte and a porous ceramic fiber substrate in a third arrangement in association with a composite cathode and a liquid electrolyte; and

FIG. 4 illustrates a process to form the hybrid electrochemical cell of FIG. 3.

### DETAILED DESCRIPTION

For the purpose of promoting an understanding of the principles of the disclosure, reference will now be made to the embodiments illustrated in the drawings and described in the following written specification. It is understood that no limitation to the scope of the disclosure is thereby intended. It is further understood that the disclosure includes any alterations and modifications to the illustrated embodiments and includes further applications of the principles of the disclosure as would normally occur to one skilled in the art to which this disclosure pertains.

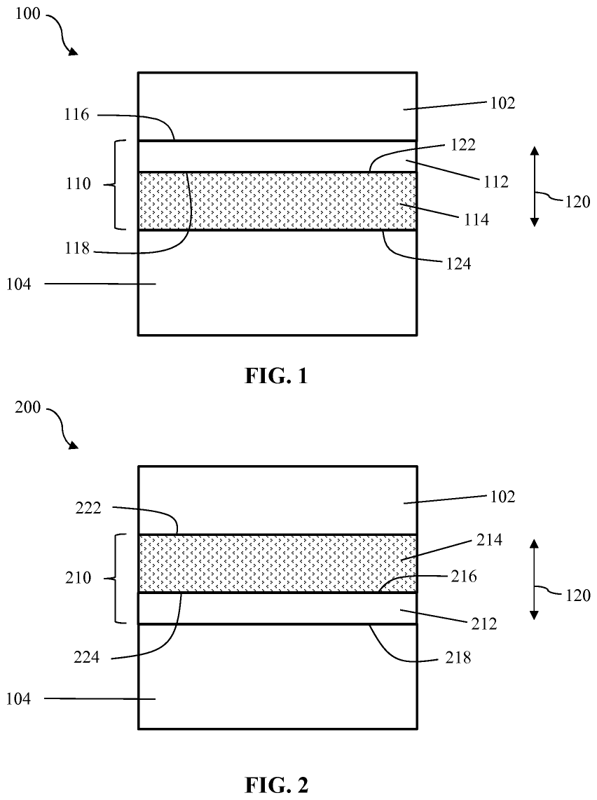

FIG. 1 depicts an electrochemical cell 100. The electrochemical cell 100 includes an anode or negative electrode 102, a cathode or positive electrode 104, and an electrolyte structure 110 with a first portion 112 and a second portion 114. The anode 102 includes Li metal or some other Li-insertion material that can reversibly insert and extract Li ions electrochemically. The anode 102 is sized such that it has at least as much capacity as the associated cathode 104, and preferably at least 10% excess capacity and up to greater than 50% capacity in some embodiments.

The cathode 104 includes a mixture of at least an active material and a matrix configured to conduct the primary ions of relevance to the cell 100. The active material in various embodiments includes a sulfur or sulfur-containing material (e.g., PAN-S composite or Li₂S); an air electrode; Li-insertion materials such as NCM, LiNi_{0.5}Mn_{1.5}O₄, Li-rich layered oxides, LiCoO₂, LiFePO₄, LiMn₂O₄; Li-rich NCM, NCA, and other Li intercalation materials, or blends thereof; or any other active material or blend of materials that react with and/or insert Li cations and/or electrolyte anions.

The matrix in various embodiments includes Li-conducting gel, polymer, or other solid electrolyte. Solid electrolyte materials in the cathode 104 may further include lithium conducting garnets, lithium conducting sulfides (e.g., Li₂S—P₂S₅) or phosphates, Li₃P, UPON, Li-conducting polymer (e.g., polyethylene oxide (PEO) or polycaprolactone (PCL)), Li-conducting metal-organic frameworks, Li₃N, Li₃P, thio-LISiCONs, Li-conducting NaSICONs, Li₁₀GeP₂S₁₂, lithium polysulfidophosphates, or other solid Li-conducting material. Other materials in the cathode 104 may include electronically conductive additives such as carbon black, binder material, metal salts, plasticizers, fillers such as SiO₂, or the like. The cathode materials are selected to allow sufficient electrolyte-cathode interfacial area for a desired design. The cathode 104 may be greater than 1 micron in thickness, preferably greater than 10 microns, and more preferably greater than 40 microns. In one embodiment, the composition of the cathode 104 includes approximately 60 to 85 weight percent active material, approximately 3 to 10 weight percent carbon additive, and 15 to 35 weight percent catholyte.

The first portion 112 of the electrolyte structure 110 shown in FIG. 1 forms a thin film solid electrolyte. The first portion 112 includes a glassy material such as LiPON or another glassy material with similar or greater Li-ion conductivity. The first portion 112 has a first anode-facing side 116 and a first cathode-facing side 118 spaced from first anode-facing side 116 in a first direction 120. As shown in the embodiment of FIG. 1, the first anode-facing side 116 of the first portion 112 is configured to adhere to or otherwise contact the anode 102. In other words, the first portion 112 is positioned against the anode 102. The first direction 120 corresponds generally to the direction in which the respective thicknesses of the structures of the cell 100 are characterized and compared in this disclosure. For example, the first portion 112 has a thickness in a range of about 100 nanometers to several microns relative to the first direction 120. In other embodiments, the first portion 112 has a smaller or larger thickness than that described with reference to FIG. 1.

The second portion 114 of the electrolyte structure 110 shown in FIG. 1 includes a porous ceramic fiber material. In some embodiments, the porous ceramic fiber material of the second portion 114 includes titanium oxide. The porous ceramic fiber material in other embodiments includes other transition-metal oxides. In yet further embodiments, the porous ceramic fiber material 114 includes other ceramics. As used herein, the term “porous ceramic fiber material” includes any material whose nanoscale components primarily include ceramic nanowires, especially transition-metal oxide nanowires.

The second portion 114 of the electrolyte structure 110 has a second anode-facing side 122 and a second cathode-facing side 124 spaced from the second anode-facing side 122 in the first direction 120. As shown in the embodiment of FIG. 1, the second anode-facing side 122 of the second portion 114 is configured to adhere to or otherwise contact the first cathode-facing side 118 of the first portion 112. The second cathode-facing side 124 of the second portion 114 is configured to adhere to or otherwise contact the cathode 104. In other words, the second portion 114 is positioned between the first portion 112 and the cathode 104. The second portion 114 has a thickness in a range of about 10 to 20 microns. In other embodiments, the second portion 114 has a smaller or larger thickness than that described with reference to FIG. 1.

The second portion 114 in some embodiments is bendable due to the ceramic nanowires. In other embodiments, the ceramic nanowires are arranged in a manner that reduces flexure in the second portion 114. In some embodiments, the ceramic nanowires have an average diameter of approximately 50 nanometers though in other embodiments the average diameter is greater or less than 50 nanometers. The ceramic nanowires define a plurality of pores dispersed throughout the thickness of the second portion 114 and opening to the surface of the second portion. The pores are typically irregularly formed with a size of around 100 nanometers. In other embodiments, the pores have a size that is greater or less than 100 nanometers. The ceramic nanowires in some embodiments are bonded to one another at their junctions to form the second portion of the electrolyte structure 110.

FIG. 2 depicts an electrochemical cell 200. The cell 200 is similar to the cell 100 of FIG. 1 in that the cell 200 includes the anode 102, the cathode 104, and an electrolyte structure 210. The electrolyte structure 210 of the cell 200 includes a first portion 212 and a second portion 214 similar to the first portion 112 and the second portion 114 of the electrolyte structure 110. The compositions and other attributes of the first portion 212 and the second portion 214 of the electrolyte structure 210 are essentially identical to those of the first portion 112 and the second portion 114 described with reference to the electrolyte structure 110. However, the positions of the first portion 212 and the second portion 214 in the electrolyte structure 210 are reversed relative to the anode 102 and the cathode 104 as compared to the positions of the first portion 112 and the second portion 114 in the electrolyte structure 110.

In particular, as shown in FIG. 2, the second anode-facing side 222 of the second portion 214 is configured to adhere to or otherwise contact the anode 102. In other words, the second portion 214, which includes the porous ceramic fiber material, is positioned against the anode 102. Similarly, the first anode-facing side 216 of the first portion 212 is configured to adhere to or otherwise contact the second cathode-facing side 224 of the second portion 214. The first cathode-facing side 218 of the first portion 212 is configured to adhere to or otherwise contact the cathode 104. In other words, the first portion 212 of the electrolyte structure 210, which includes the solid electrolyte, is positioned between the second portion 214 and the cathode 104.

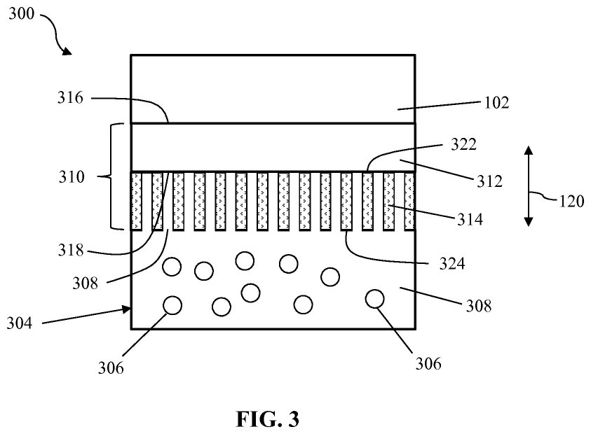

FIG. 3 depicts an electrochemical cell 300. The cell 300 is similar to the cell 100 of FIG. 1 in that the cell 300 includes the anode 102 and an electrolyte structure 310. The electrolyte structure 310 of the cell 300 includes a first portion 312 and a second portion 314 similar to the first portion 112 and the second portion 114 of the electrolyte structure 110. The compositions and other attributes of the first portion 312 and the second portion 314 of the electrolyte structure 310 are essentially identical to those of the first portion 112 and the second portion 114 described with reference to the electrolyte structure 110.

In particular, as shown in FIG. 3, the first portion 312 has a first anode-facing side 316 and a first cathode-facing side 318. The first anode-facing side 316 is configured to adhere to or otherwise contact the anode 102. In other words, the first portion 312, which includes the solid electrolyte, is positioned against the anode 102. The second portion 314 has a second anode-facing side 322 and a second cathode-facing side 324. The second anode-facing side 322 of the second portion 314 is configured to adhere to or otherwise contact the first cathode-facing side 318 of the first portion 312.

The cell 300 further includes a porous composite cathode 304 that includes particles of cathode active material 306 (“CAM”) and liquid electrolyte 308. The composite cathode 304 has a thickness in a range of about 50 to 150 microns. In other embodiments, the composite cathode 304 has a smaller or larger thickness than that described with reference to FIG. 3. The second cathode-facing side 324 of the second portion 314 is configured to adhere to or otherwise contact the composite cathode 304. In other words, the second portion 314, which includes the porous ceramic fiber material, is positioned between the first portion 312 and the composite cathode 304. The liquid electrolyte 308 fills in the pores of the porous ceramic fiber material in the second portion 314 of the electrolyte structure 310. FIG. 3 shows the pores of the porous ceramic fiber material enlarged and arranged in parallel relationship with one another for illustrative purposes only. The pores of the porous ceramic fiber material are typically irregularly formed and sized as described above in connection with the embodiment of FIG. 1.

The electrolyte structures 110, 210, and 310 described herein have numerous advantages. In some instances, these advantages are due to the relationship of the electrolyte structures 110, 210, and 310 to the other structures of the cells. In other instances, the advantages result from the processes used to form the electrolyte structures 110, 210, and 310, the processes used to incorporate said electrolyte structures 110, 210, 310 into cells, or both. The porous ceramic fiber material used in connection with the electrolyte structures 110, 210, and 310 is particularly useful as one or both of (1) a mechanical support for a solid electrolyte and (2) a substrate for improving the processing of a solid electrolyte.

In general, as a mechanical support, the porous ceramic fiber material strengthens the electrolyte from internal stresses (e.g. Li dendrites) or external stresses in the battery fabrication process or in battery operation (e.g. mechanical or temperature conditions). As a substrate, the porous ceramic fiber material provides a surface upon which to grow or otherwise process another electrolyte. An electrolyte processed in connection with a porous ceramic fiber material can have desired electrochemical properties, such as low cost, high Li stability, or high ionic conductivity, and be formed from a glass or a ceramic. The electrolyte structures 110, 210, and 310 have the following additional configurations and advantages.

The porous ceramic fiber material (i.e., the second portions 114, 214, and 314) in some embodiments provides mechanical support for the electrolyte (i.e., the first portions 112, 212, and 312). The porous ceramic fiber material is added during the electrolyte manufacturing stage, during the cell manufacturing stage, or anywhere that a similar material is typically added as a separator. The porous ceramic fiber material is meant to be used in conjunction with an electrolyte, such as LiPON, that has otherwise desirable properties (e.g. ionic conductivity, stability against a Li-metal anode) but has less than desirable mechanical strength. The porous ceramic fiber material adds mechanical reinforcement to the overall electrolyte. The addition of the porous ceramic fiber material strengthens the electrolyte from internal stresses (e.g. Li dendrites) or external stresses (e.g. mechanical or temperature conditions). The porous ceramic fiber material also adds flexibility to the overall electrolyte, thereby significantly improving the processability of the material.

The porous ceramic fiber material in some embodiments provides a substrate for deposition of an electrolyte. The electrolyte is deposited via sputtering, vapor deposition, or any other deposition method. The optimal thermal properties of the fiber material allow a smooth layering of the deposition, thereby enhancing surface contact and reducing mechanical stresses. In some embodiments, the fiber material is removed by chemical or mechanical processes after being incorporated into the cell. In other embodiments, the fiber material remains in the final cell if the material has sufficient ionic-transport and electrochemical-stability properties.

In some embodiments, the porous ceramic fiber material provides a surface upon which to grow thin layers for glassy electrolytes. These glassy electrolytes are of interest due to several unique advantages for their use with Li metal. These glassy electrolytes usually have a thickness in a range of 2 to 5 um because of their intrinsically high resistivity and, therefore, require a suitable host upon which to grow the thin film. The porous ceramic fiber material provides a suitable host. Different types of glassy materials can be considered by this approach, including LiPON and other lithium oxynitrides. The enhanced thermal stability of the porous ceramic fiber material allows smoother surfaces and, thus, lower interfacial resistivities and/or lower mechanical stresses associated with nonuniform morphology.

The porous ceramic fiber material in yet further embodiments provides a substrate for processing or production of an electrolyte, such as by tape casting, dip-coating, or some other method of production, which may also lend mechanical or surface-adhesion functionalities. The porous ceramic fiber material can be used as a substrate with which tape casting process of other ceramic oxides can be performed. An example would be the use of tape casting of garnet (LLZO and its variants) along with sintering agents and pore formers, on the porous ceramic substrate. The usual sintering process will also achieve additional mechanical reinforcement and flexibility due to the ceramic porous fibers. Tuning the surface properties of the ceramic fibers could further enhance the adhesion of the garnet material on to the ceramic substrate.

The porous ceramic fiber material can also be used as a substrate to dip-coat sulfide based ceramic materials. Dip-coating could be done either on a solution of sulfide based electrolytes (in a suitable solvent) or from the melt of sulfides (usually low temperature melts compared to oxides). Dip-coating offers uniform imbibing of the pores of the porous ceramic separator and formation of a potentially defect free surface. The material can then be subjected to annealing/sintering without significant change in dimensions because of the stabilization of the geometric area by the ceramic support.

The porous ceramic fiber material in still further embodiments provides a unique surface functionality to enhance adhesion of the electrolyte material (sulfides, oxides, glass) and to add mechanical flexibility to enhance the handling ability of the separators. The enhanced handling properties are very much desirable to enable roll to roll processing of the battery cell production.

The electrolyte structures 110, 210, and 310 are configured for use as the sole electrolyte, such as in the cell 100 (FIG. 1) and the cell 200 (FIG. 2) or in a hybrid cell, such as the cell 300 (FIG. 3). In the hybrid cell 300, the porous ceramic fiber material provides a substrate for the dense ceramic or glass layer that is interfaced with the Li metal negative electrode, while the pores of the fiber material are filled with a liquid or polymer electrolyte (i.e., catholyte) that also fills the pores of the composite cathode 304.

Standard LiPON-type electrolytes usually lack mechanical strength because they are formed as thin films. By adding the UPON-type material as a thin conducting layer on top of a thicker support, such as the porous ceramic fiber material described in connection with electrolyte structures 110, 210, and 310, the electrolyte material is handled more easily and can be integrated into a battery with thicker electrodes processed via cheaper conventional approaches. The support needs to have relatively much higher conductivity (approximately 1e−4 S/cm or higher) than UPON because of its much greater thickness (approximately 10 to 30 microns) compared to the LiPON layer.

This higher conductivity is provided by filling the pores of the porous ceramic fiber material with liquid electrolyte or another solid electrolyte (polymer or ceramic) with high conductivity. The porous ceramic fiber material used as a separator tends to have higher porosity than a conventional polyolefin separator used in Li-ion cells, which higher porosity further enhances the overall conductivity of the separator when electrolyte fills the pores. Moreover, the ceramic separator can be made even thinner than a conventional polyolefin separator without impacting battery safety because of its improved mechanical and thermal properties.

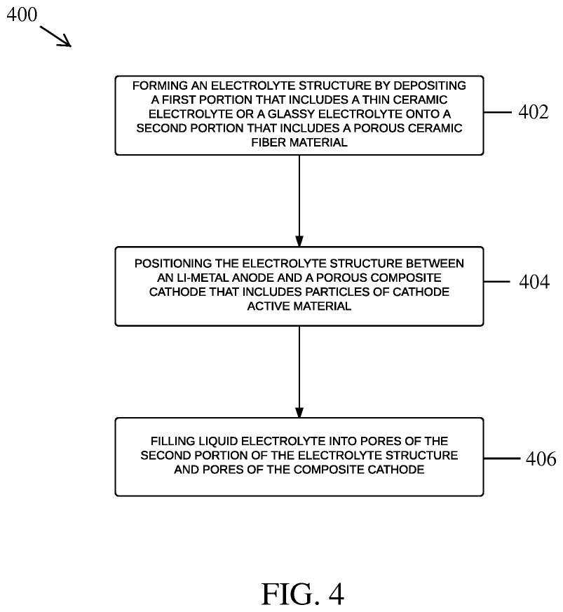

FIG. 4 depicts a process 400 to form an electrochemical cell, such as the cell 300 of FIG. 3, with an electrolyte structure including a porous ceramic fiber material. Initially, an electrolyte structure 310 is formed by depositing a first portion 312 that includes a thin ceramic or glassy solid electrolyte onto a second portion 314 that includes a porous ceramic fiber material (block 402). The second portion 314 has a thickness in a range of about 10 to 20 microns while the first portion 312 is deposited to a thickness of less than 1 micron. Once the electrolyte structure 310 is formed (block 402), the electrolyte structure 310 is positioned between an anode 102 that includes Li-metal and a porous composite cathode 304 that includes particles of CAM 306 (block 404).

The composite cathode 304 has a thickness in a range of about 50 to 150 microns. The amount of Li metal in the anode 102 generally corresponds to less than 20% of the capacity contained in the cathode 304, if the cathode 304 is a source of Li. For other cathode materials that start in the charged state (delithiated), the capacity is built into the negative electrode. Liquid electrolyte 308 is then filled into the pores of the porous ceramic fiber material of the second portion 314 and the pores of the composite cathode 304 (block 406).

The electrolyte structures disclosed herein as well as batteries and devices which include the electrolyte structures can be embodied in a number of different types and configurations. The following embodiments are provided as examples and are not intended to be limiting.

Embodiment 1: A porous ceramic fiber material as a mechanical support for a solid electrolyte.

Embodiment 2: Where the solid electrolyte is LiPON or some other thin film.

Embodiment 3: Where the porous ceramic fiber material is placed in the cell in between the cathode and the electrolyte [FIGS. 1 and 3] or in between the anode and the electrolyte [FIG. 2].

Embodiment 4: Where the porous ceramic fiber material is used with a composite cathode as shown in FIG. 3, and/or is filled with liquid electrolyte.

Embodiment 5: A porous ceramic fiber material that achieves good adhesion with the electrolyte and/or the anode and/or the cathode.

Embodiment 6: Where the porous ceramic fiber material is placed in the cell in between the cathode and the electrolyte [FIG. 1, 3] or in between the anode and the electrolyte [FIG. 2].

Embodiment 7: Where the porous ceramic fiber material contains liquid electrolyte and is adjacent to a composite cathode [FIG. 3].

Embodiment 8: A porous ceramic fiber material as a substrate to make a solid electrolyte.

Embodiment 9: Where the solid electrolyte is LiPON or some other thin film.

Embodiment 10: Where the solid electrolyte is deposited via sputtering or some other deposition method.

Embodiment 11: Where the solid electrolyte is processed via tape-casting, dip-coating, or some other processing method.

Embodiment 12: Where the porous ceramic fiber material is placed in the cell in between the cathode and the electrolyte [FIG. 1, 3] or in between the anode and the electrolyte [FIG. 2].

Embodiment 13: Where the porous ceramic fiber material is removed by some chemical, mechanical, or other means before being placed in the cell.

Embodiment 14: Where liquid electrolyte is added to the porous ceramic fiber material which then is adjacent to a composite cathode [FIG. 3].

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A solid-state battery cell, comprising:
a positive electrode;
a negative electrode that includes lithium metal; and
an electrolyte structure disposed between the positive electrode and the negative electrode, the electrolyte structure including a first portion configured as a thin film solid electrolyte and a second portion positioned adjacent to the first portion, the second portion including a porous ceramic fiber material that contacts the thin film solid electrolyte.

2. The solid-state battery cell of claim 1, wherein the porous ceramic fiber material is configured to mechanically support the thin film solid electrolyte by strengthening the thin film solid electrolyte from internal stresses and external stresses associated with one or more of fabrication and operation of the battery cell.

3. The solid-state battery cell of claim 1, wherein the porous ceramic fiber material is configured as a substrate on which the thin film solid electrolyte is deposited, grown, or otherwise formed.

4. The solid-state battery cell of claim 1, wherein the porous ceramic fiber material is configured to enhance adhesion with one or more of the thin film solid electrolyte, the positive electrode, and the negative electrode.

5. The solid-state battery cell of claim 1, wherein a surface of the second portion has surface properties configured to be tuned so as to further enhance adhesion of the porous ceramic fiber material with the one or more of the thin film solid electrolyte, the positive electrode, and the negative electrode.

6. The solid-state battery cell of claim 1, wherein:
the first portion of the electrolyte structure has a first side configured to contact the negative electrode and a second side spaced from the first side and facing the second portion, and
the second portion of the electrolyte structure has a third side configured to contact the positive electrode and a fourth side spaced from the third side and configured to contact the second side of the first portion.

7. The solid-state battery cell of claim 1, wherein:
the first portion of the electrolyte structure has a first side configured to contact the positive electrode and a second side spaced from the first side and facing the second portion, and
the second portion of the electrolyte structure has a third side configured to contact the negative electrode and a fourth side spaced from the third side and configured to contact the second side of the first portion.

8. The solid-state battery cell of claim 1, wherein:
the first portion of the electrolyte structure has a first thickness in a range of 100 nanometers to 5 microns between one of the positive and negative electrodes and the second portion, and
the second portion of the electrolyte structure has a second thickness in a range of 10 to 20 microns between the other one of the positive and negative electrodes and the first portion.

9. The solid-state battery cell of claim 8, wherein the second portion of the electrolyte structure has a conductivity of at least 1e−4 S/cm or higher.

10. The solid-state battery cell of claim 1, wherein the thin film solid electrolyte of the first portion is formed from lithium phosphorous oxynitride (LiPON).

11. A battery cell, comprising:
a negative electrode that includes lithium metal;
a porous composite positive electrode that includes particles of active material and liquid electrolyte; and
an electrolyte structure disposed between the negative electrode and the positive electrode, the electrolyte structure including a first portion configured as thin film solid electrolyte and a second portion positioned adjacent to the first portion, the second portion including a porous ceramic fiber material that contacts the thin film solid electrolyte,
wherein the first portion of the electrolyte structure contacts the negative electrode and the pores of the porous ceramic fiber material arc filled with the liquid electrolyte.

12. The battery cell of claim 11, wherein the porous ceramic fiber material is configured to mechanically support the thin film solid electrolyte by strengthening the thin film solid electrolyte from internal stresses and external stresses associated with one or more of fabrication and operation of the battery cell.

13. The battery cell of claim 11, wherein the porous ceramic fiber material is configured to enhance adhesion with one or more of the thin film solid electrolyte, the positive electrode, and the negative electrode.

14. The battery cell of claim 11, wherein the thin film solid electrolyte of the first portion is formed from a dense ceramic or glass layer.

15. The battery cell of claim 11, wherein:
the first portion of the electrolyte structure has a first side that contacts the negative electrode and a second side spaced from the first side and facing the second portion, the first side and the second side defining a first thickness of the first portion,
the second portion of the electrolyte structure has a third side configured to contact the positive electrode and a fourth side spaced from the third side and configured to contact the second side of the first portion, the third side and the fourth side defining a second thickness of the second portion,
the positive electrode has a fifth side that contacts the fourth side of the second portion and a sixth side spaced from the fifth side and facing away from the second portion, the fifth side and the sixth side defining a third thickness of the positive electrode, and
the first thickness is less than 1 micron, the second thickness is in a range of 10 to 20 microns, and the third thickness is in a range of 50 to 150 microns.

16. A method for producing a battery cell, comprising:
fabricating an electrolyte structure by forming a first portion configured as a thin film solid electrolyte on a second portion that includes a porous ceramic fiber material, the porous ceramic fiber material contacting the thin film solid electrolyte; and
positioning the electrolyte structure between a positive electrode and a lithium metal negative electrode of the battery cell such that the electrolyte structure contacts the positive electrode and the negative electrode.

17. The method of claim 16, wherein fabricating the electrolyte structure includes forming the thin film solid electrolyte on the porous ceramic fiber material via a deposition process.

18. The method of claim 16, wherein the thin film solid electrolyte is a glassy electrolyte and wherein fabricating the electrolyte structure includes growing one or more thin layers of the glassy electrolyte on the porous ceramic fiber material.

19. The method of claim 16, wherein:
the thin film solid electrolyte is a ceramic oxide and fabricating the electrolyte structure includes forming the thin film solid electrolyte on the porous ceramic fiber material via tape casting, or
the thin film solid electrolyte is a sulfide-based ceramic material and fabricating the electrolyte structure includes forming the thin film solid electrolyte on the porous ceramic fiber material via dip coating.

20. The method of claim 16, further comprising removing the porous ceramic fiber material after the electrolyte structure is positioned between the positive electrode and the negative electrode.
